(19) United States
(12) Patent Application Publication
(10) Pub. No.: US 2006/0083298 A1
(43) Pub. Date: Apr. 20, 2006

(54) Reference picture management in video coding

(75) Inventors: Ye-Kui Wang, Tampere (FI); Miska Hannuksela, Ruutana (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/116,109

(22) Filed: Apr. 26, 2005

Related U.S. Application Data
(60) Provisional application No. 60/618,974, filed on Oct. 14, 2004.

(51) Int. Cl. H04N 11/04; H04N 11/02; H04N 7/12; H04B 1/66

(52) U.S. Cl. 375/240.01

(57) ABSTRACT

A method for encoding a sequence of pictures comprising using one or more pictures as reference pictures, labeling the reference pictures with a first parameter, signaling the first parameter to a decoder, and using a reference picture management, wherein all the reference pictures are identified by a second parameter which is derived on the basis of the first parameter.

### CROSS REFERENCE TO RELATED APPLICATIONS

This application claims priority under 35 USC §119 to U.S. Provisional Patent Application No. 60/618,974 filed on Oct. 14, 2004.

### FIELD OF THE INVENTION

The invention relates to reference picture management in video coding and decoding.

### BACKGROUND OF THE INVENTION

There are a number of video coding standards including ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 or ISO/IEC MPEG-4 AVC. H.264/AVC is the work output of a Joint Video Team (JVT) of ITU-T Video Coding Experts Group (VCEG) and ISO/IEC MPEG.

In addition, there are efforts working towards new video coding standards. One is the development of scalable video coding (SVC) standard in MPEG. This will become MPEG-21 Part 13. The second effort is the development of China video coding standards organized by the China Audio Visual coding Standard Work Group (AVS). AVS finalized its first video coding specification, AVS 1.0 targeted for SDTV and HDTV applications, in February 2004. Since then the focus has moved to mobile video services.

Many of the available video coding standards utilize motion compensation, i.e. predictive coding, to remove temporal redundancy between video signals for high coding efficiency. In motion compensation, one or more previously decoded pictures are used as reference pictures of the current picture being encoded or decoded. When encoding one block of pixels of the current picture (the current block), a reference block from the reference picture is searched such that the difference signal between the current block and the reference block requires a minimum number of bits to represent. Encoding of the displacement between the current block and the reference block may also be considered in searching the reference block. Further, the distortion of the reconstructed block may also be considered in searching the reference block.

In a coded video bit stream, some pictures may be used as reference pictures when encoding of other pictures, while some may never be used as reference pictures. A picture that is not to be used as a reference picture is called a non-reference picture. The encoder should then signal whether a picture is a reference picture to a decoder such that the decoder does not need to store the picture for motion compensation reference. Initially, each reference picture should be stored in the post-decoder buffer or decoded picture buffer and marked as “used for reference”. However, when a reference picture is not used for reference anymore, it should be marked as “unused for reference”. Marking of a reference picture as “used for reference” or “unused for reference” among other things are done by a reference picture management process.

The reference picture selected for coding or decoding a block may be a recently decoded picture (typically called short-term reference picture), or a decoded picture that is far preceding the currently coded picture in decoding order (typically called long-term reference picture). In FIG. 1 there is depicted an example of a picture stream 100 which comprises reference pictures 101, 103, 105, 106, 108, 110 and non-reference pictures 102, 104, 107, 109. The reference picture 101 is assumed to be a short-term reference picture (when encoding of picture 103 and 102) while the reference picture 105 is assumed to be a long-term reference picture (when encoding of picture 106). The pictures between the long-term reference picture 105 and the picture 106 which uses the long-term reference picture as a reference picture are not shown in FIG. 1.

In the standards that allow for both short-term and long-term reference pictures, e.g. H.263 and H.264/AVC, reference picture management processes are separated between short-term reference pictures and long-term reference pictures. In addition, a process is specified to mark a short-term reference picture as a long-term reference picture. In H.264/AVC, a short-term reference picture is identified by the variable PicNum, and a long-term reference picture is identified by the variable LongTermPicNum. Both PicNum and LongTermPicNum are specified in subclause 8.2.4.1 of the H.264/AVC specification. Accordingly, all other reference management operations such as reference picture list construction (specified in subclause 8.2.4 of the H.264/AVC specification) and reference picture marking (specified in subclause 8.2.5 of the H.264/AVC specification) are separated for short-term reference pictures and long-term reference pictures.

In the standard H.263 Annex N (reference picture selection mode), the 10-bit temporal reference index TRI or RTR representing temporal reference is used to identify reference pictures. One disadvantage in this solution is that the temporal distance between the reference picture and the current picture is limited to be less than 1024 units. The unit is defined according to the active picture clock frequency. In other words, the so-called long-term reference picture is not enabled.

In the standard H.263 Annex U (enhanced reference picture selection mode), the 10-bit picture number (PN) that is incremented by 1 for each reference picture (called as “stored picture” therein) is used to identify short-term reference pictures. The variable length coded LPIN representing long-term picture index is used to identify long-term reference pictures.

In the standard H.264/AVC, PicNum and LongTermPicNum are used, respectively, to identify short-term and long-term reference pictures. PicNum and LongTermPicNum are similar as PN and LPIN, respectively, in the standard H.263 Annex U, but both are extended for both progressive coding and interlace coding. PicNum has yet another difference from PN, being that the value of PicNum may be negative and is degressive with the difference between the decoding order of the current picture and the decoding order of the reference picture. For example, the PN of a list of reference pictures may be 1022, 1023, 0,1, 2, while the PicNum of the same list of reference pictures may be −2, −1, 0,1, 2.

For example, patent applications US-09/892977, WO 01/86960 and GB 2382403, and the standard H.263 Annex U and the standard H.264/AVC disclose some prior art solutions to reference picture management in video coding.

The separated management of short-term and long-term reference pictures results in complex reference picture management operations, hence increased implementation complexity for both hardware and software implementations.

### SUMMARY OF THE INVENTION

This invention provides a reference picture management solution for implementation in e.g. video encoders and/or decoders whether or not the usage of long-term reference picture approach is supported.

According to an example embodiment of the present invention, the reference pictures are managed in the same way no matter how far away they are from the current picture being encoded or decoded in decoding order. Therefore the reference pictures are not needed to be separated as short-term or long-term reference pictures. A reference picture is identified by a variable whose value can be unique for a reference picture throughout the coded video sequence. That variable can also be used in all the management processes of reference pictures in addition to identify reference pictures.

In the present invention a uniform reference picture management process is disclosed that may enable simplified video decoder and/or encoder implementations when long-term reference picture implementation is supported.

In the standard H.264/AVC there is a syntax table for reference picture reordering. There are eight syntax elements (i.e. coding points) in the syntax table. Two of the syntax elements are not needed when the present invention is used. In the standard H.264/AVC there is also a syntax table for reference picture remarking. There are eight syntax elements in the syntax table from which four are not needed in the implementations of the present invention.

The invention can largely be implemented as a software wherein the software can be simplified to some extent.

The proposed reference picture reordering and marking processes may enable efficient signaling of information required for the reference picture management processes.

### DESCRIPTION OF THE DRAWINGS

In the following the present invention will be described in more detail with respect to the appended drawings in which

FIG. 1 shows an example of a picture stream which comprises reference pictures and non-reference pictures,

FIG. 2 shows an example of a picture stream which comprises frame numbers,

FIG. 3 shows an example of a signal according to the present invention,

FIG. 4 shows an example of a method according to the present invention as a flow diagram,

FIG. 5 depicts an advantageous embodiment of the system according to the present invention,

FIG. 6 depicts an advantageous embodiment of the encoder according to the present invention,

FIG. 7 depicts an advantageous embodiment of the decoder according to the present invention,

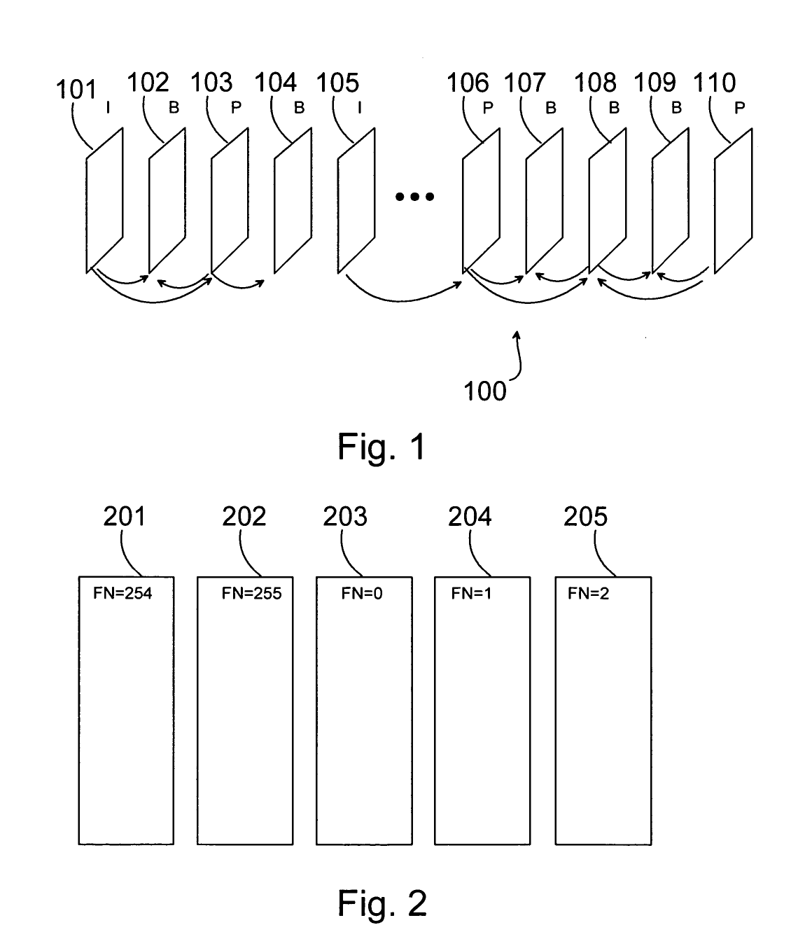

### DETAILED DESCRIPTION OF THE INVENTION

The following implementation aspects of the current invention are described in the way for progressive coding only, where a picture is equivalently a frame. However, it is obvious for them to be extended for use in both progressive coding and interlace coding, where a picture may either be a field or a frame, in the way similarly as in the prior art according to the standard H.264/AVC. Further, the following aspects of the current invention are described for forward prediction only. It is also obvious for those to be extended for bi-prediction as defined in the standard H.264/AVC.

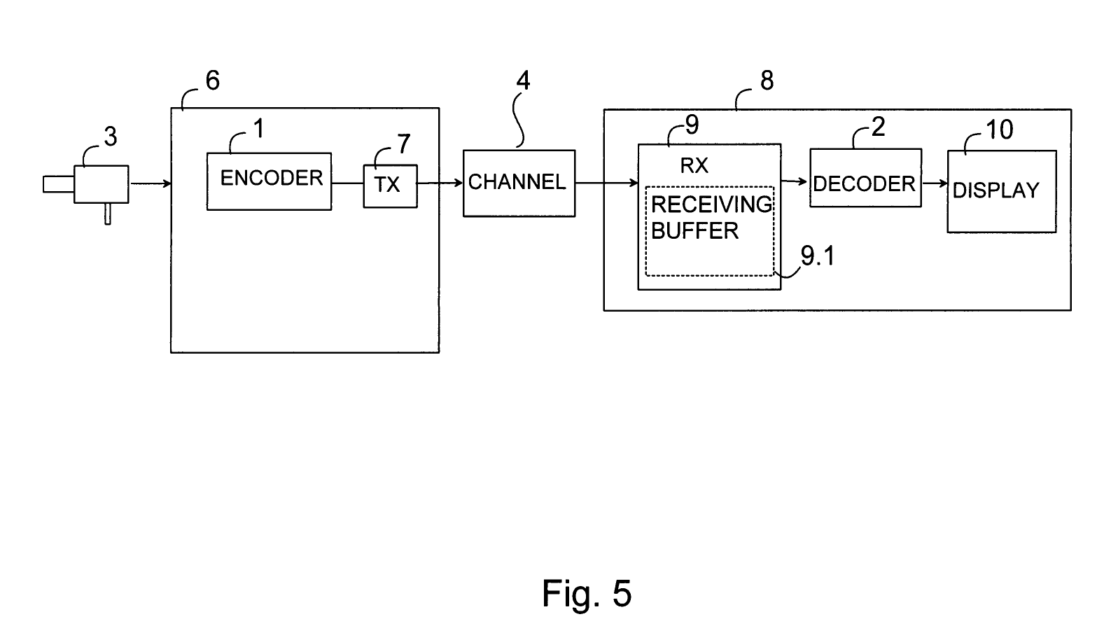

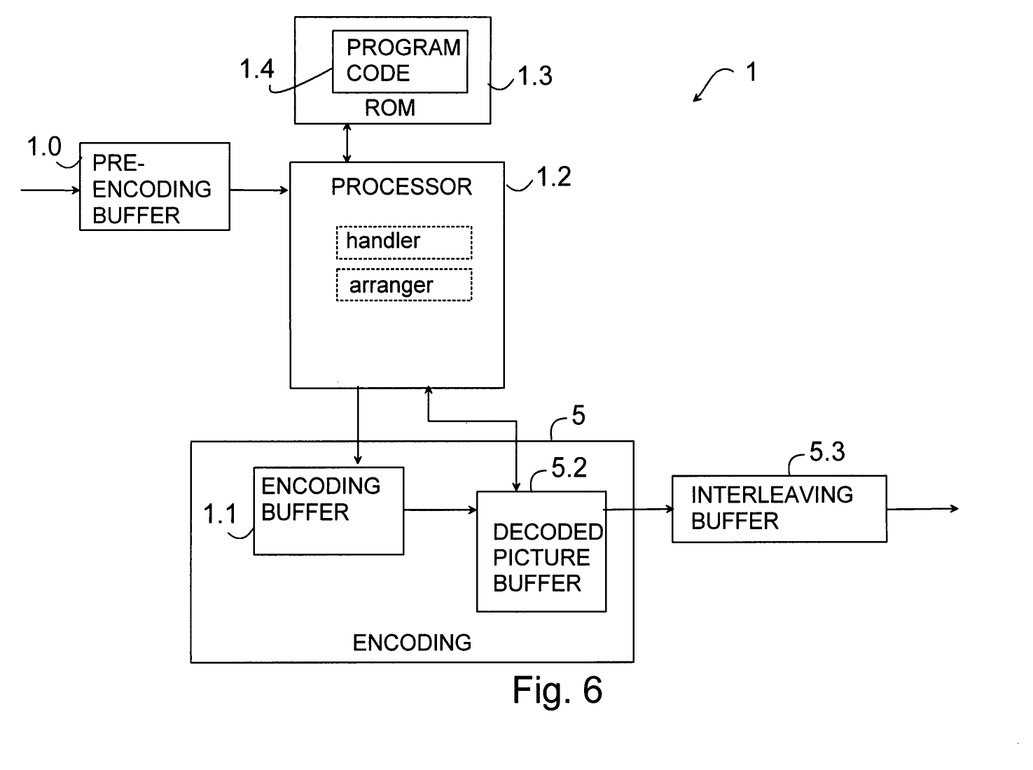

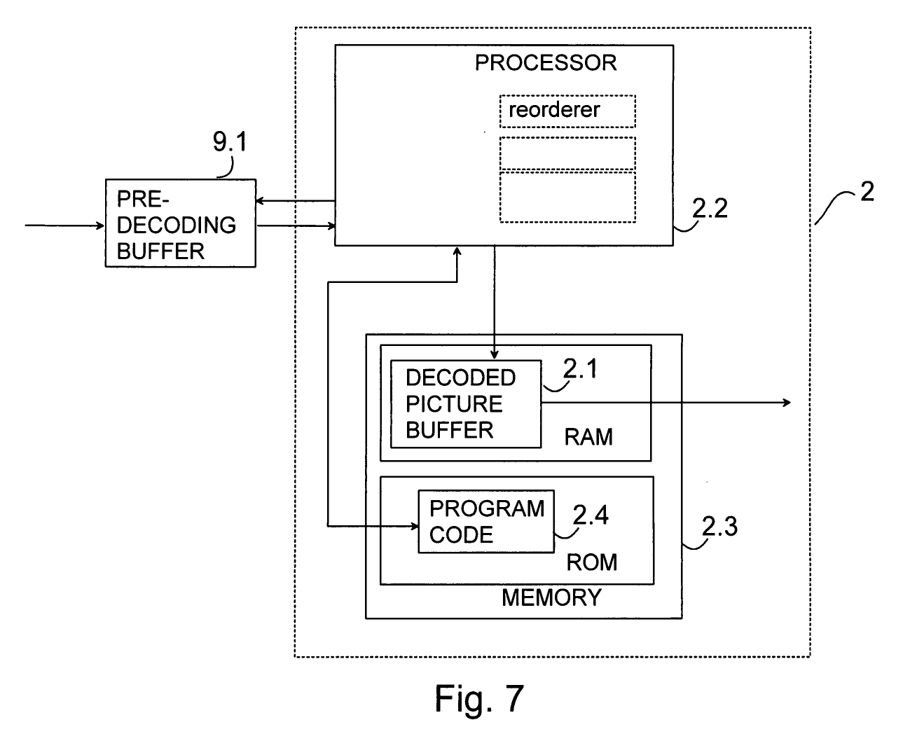

In the following the invention will be described in more detail with reference to the system of FIG. 5, the encoder 1 of FIG. 6 and decoder 2 of FIG. 7. The pictures to be encoded can be, for example, pictures of a video stream from a video source 3, e.g. a camera, a video recorder, etc. The pictures (frames) of the video stream can be divided into smaller portions such as slices. The slices can further be divided into blocks. In the encoder 1 the video stream is encoded to reduce the information to be transmitted via a transmission channel 4, or to a storage media (not shown). Pictures of the video stream are input to the encoder 1. The encoder has an encoding buffer 1.1 (FIG. 6) for temporarily storing some of the pictures to be encoded. The encoder 1 also includes a memory 1.3 and a processor 1.2 in which the encoding tasks according to the invention can be applied. The memory 1.3 and the processor 1.2 can be common with the transmitting device 6 or the transmitting device 6 can have another processor and/or memory (not shown) for other functions of the transmitting device 6. The encoder 1 performs motion estimation and/or some other tasks to compress the video stream. The reference picture has to be stored in a buffer (e.g. in the decoded picture buffer 5.2) as long as it is used as a reference picture. The encoder 1 may also insert information on display order of the pictures into the transmission stream.

From the encoding process the encoded pictures are moved to an picture interleaving buffer 5.3, if necessary. Furthermore, the encoded reference pictures are decoded and inserted into the decoded picture buffer 5.2 of the encoder. The encoded pictures are transmitted from the encoder 1 by the transmitter 7 to the receiving device 8 via the transmission channel 4. In the receiving device 8 the receiver 9 receives the transmitted information and performs necessary operations to transform signals transmitted by the transmitter 7 into form suitable for the decoder 2 which is known as such. In the decoder 2 the encoded pictures are decoded to form uncompressed pictures corresponding as much as possible to the encoded pictures.

The decoder 1 also includes a memory 2.3 and a processor 2.2 in which the decoding tasks can be applied. The memory 2.3 and the processor 2.2 can be common with the receiving device 8 or the receiving device 8 can have another processor and/or memory (not shown) for other functions of the receiving device 8.

Encoding

Let us now consider the encoding-decoding process in more detail. Pictures from the video source 3 are entered to the encoder 1 and stored in the encoding buffer 1.1 when necessary. The encoding process is not necessarily started immediately after the first picture is entered to the encoder, but after a certain amount of pictures are available in the encoding buffer 1.1. Then the encoder 1 tries to find suitable candidates from the pictures to be used as the reference frames for motion estimation. The encoder 1 then performs the encoding to form encoded pictures. The encoded pictures can be, for example, predicted pictures (P), bi-predictive pictures (B), and/or intra-coded pictures (I). The intra-coded pictures can be decoded without using any other pictures, but other type of pictures need at least one reference picture before they can be decoded. Pictures of any of the above mentioned picture types can be used as a reference picture.

The encoder 1 attaches for example two time stamps to the pictures: a decoding time stamp (DTS) and output time stamp (OTS). The decoder can use the time stamps to determine the correct decoding time and time to output (display) the pictures. However, those time stamps are not necessarily transmitted to the decoder or it does not use them. The buffering model is presented next. The pre-encoding buffer 1.0, decoded picture buffer 5.2 and interleaving buffer 5.3 are initially empty. Uncompressed pictures in capturing order are inserted to the pre-encoding buffer. When any temporal scalability scheme is applied, more than one uncompressed picture is buffered in the pre-encoding buffer before encoding. After this initial pre-encoding buffering, the encoding process starts. The encoder 5 performs the encoding process. As a result of the encoding process, the encoder produces decoded reference pictures and encoded pictures and removes picture that was encoded from the pre-encoding buffer. The decoded reference pictures are inserted in the decoded picture buffer 5.2 and encoded pictures are inserted in the interleaving buffer 5.3. The transmitting device selects data units of encoded pictures from the interleaving buffer to be transmitted. A transmitted data unit of an encoded picture is removed from the interleaving buffer.

Transmission

The transmission and/or storing of the encoded pictures (and the optional virtual decoding) can be started immediately after the first encoded picture is ready. This picture is not necessarily the first one in decoder output order because the decoding order and the output order may not be the same.

When the first picture of the video stream is encoded the transmission can be started. The encoded pictures are optionally stored to the interleaving buffer 5.3. The transmission can also start at a later stage, for example, after a certain part of the video stream is encoded.

Decoding

The receiver 8 collects all data units of received signal(s) belonging to a picture, bringing them into a reasonable order. The strictness of the order depends on the profile employed. The received data units are stored in reception order into the receiving buffer 9.1 (pre-decoding buffer, de-interleaving buffer). The receiver 8 discards anything that is unusable, and passes the rest to the decoder 2.

The encoded pictures are decoded by the processor 2.2 and stored into the decoded picture buffer 2.1. The decoded picture buffer 2.1 contains memory places for storing a number of pictures. Those places can also be called as frame stores. The decoder 2 decodes the received pictures in the order they are removed from the de-interleaving buffer (i.e. in decoding order). The pictures which are used as reference pictures will be stored in the decoded picture buffer 2.1 as long as they are needed as reference pictures. When a reference picture is marked as “unused for reference” (or alternatively the marking “used for reference” is removed) that reference picture can be removed from the decoded picture buffer 2.1 if its output or display time is elapsed and/or a newly decoded picture can be stored onto that reference picture.

The decoder 2 should also output the decoded pictures in correct order, for example by using the ordering of the picture order counts as specified in the standard H.264/AVC, and hence the reordering process need be defined clearly and normatively.

Identification of Reference Pictures

In this invention, a variable having unique values for all the reference pictures within a coded video sequence is used to identify reference pictures, regardless how far a reference picture, within the same coded video sequence, is away from the current picture, in temporal order, decoding order or any other order. This variable is called as a reference picture number and it is abbreviated as RPN herein.

A coded video sequence is essentially the same as the term defined in the standard H.264/AVC. The definition for the coded video sequence is: a sequence of coded pictures that consists, in decoding order, of an instantaneous decoding refresh (IDR) picture followed by zero or more non-IDR pictures including all subsequent pictures up to but not including any subsequent IDR picture. An IDR picture is an intra coded picture after the decoding of which all following coded pictures in decoding order can be decoded without reference from any picture decoded prior to the IDR picture. The first picture of each coded video sequence is an IDR picture.

Reference picture number (RPN) is derived from the signaled information for each picture. For example, the reference picture number can be derived from temporal reference (e.g. TR in H.263 picture header) or frame number (FN) that is incremented by 1 for each reference picture in modulo arithmetic (e.g. frame_num in H.264/AVC slice header and PN as specified in H.263 Annex U).

There are some advantages when the reference picture number RPN is derived from frame number FN. First, frame number FN counts only reference pictures and second, non-reference pictures are not stored in the post-decoder picture buffer for reference. It is obvious that similar derivation method can be used to derive reference picture number RPN from other information such as temporal reference.

The frame number value of an IDR picture can be set to any integer value between 0 and the maximum frame number value MaxFN, though typically it can be set to 0. The sum of the maximum frame number value MaxFN and 1 is denoted as MaxFNplus1. MaxFNplus1 can be indicated according to the signaled information and/or the codec specification. An IDR picture is naturally a reference picture. For later pictures in the same coded video sequence in decoding order, the FN value in a picture, whether it is a reference or a non-reference picture, is equal to the FN value of the previous reference picture in decoding order plus 1 modulo MaxFNplus1 as is shown in the example of FIG. 2, where all the shown pictures are reference pictures and MaxFNplus1 is 256.

The reference picture number of a reference picture is derived based on the frame number FN as follows. For a reference picture with frame number equal to FN and stored in the post-decoder buffer 5.2, 2.1 for reference, let the parameter prevFN equal to the frame number of the previous reference picture in decoding order, and let the parameter prevRPN equal to the reference picture number of the previous reference picture. The reference picture number of the reference picture is then calculated as follows:

```
if(prevFN <= FN)
  RPN = prevRPN + EN − prevFN
else
  RPN = prevRPN + FN − prevFN + MaxFNplus1
```

Reference Picture List Initialization

The initial reference picture list indexes the reference pictures stored in the post-decoder buffer for reference such that the reference pictures are ordered starting with the reference picture with the highest RPN value and proceeding through to the reference picture with the lowest RPN value. For example, if there are four pictures stored to be used for reference, and their RPN values are 255, 502, 1027 and 1029, the initial list order is 1029, 1027, 502, 255. With this default list order, variable length coded (VLC) code 0 can be used to indicate the reference picture with RPN value 1029, code 1 can be used to indicate the reference picture with RPN value 1027, and so on.

Reference Picture List Reordering

Each predictive picture may have multiple reference pictures. These reference pictures are ordered in two reference picture lists, called RefPicList0 and RefPicList1. Each reference picture list has an initial order, and the order may be changed by the reference picture list reordering process. For example, assume that the initial order of RefPicList0 is r0, r1, r2, . . . , rm, which are coded using variable length codes. Code 0 represents r0, code 1 represents r1, and so on. If the encoder knows that r1 is used more frequently than r0, then it can reorder the list by swapping r0 and r1 such that code 1 represents r0, code 0 represents r1. Since code 0 is shorter than code 1 in code length, improved coding efficiency is achieved. The reference picture reordering process must be signaled in the bit stream so that the decoder can derive the correct reference picture for each reference picture list order.

One method for reference picture list reordering is to signal the RPN value to indicate which reference picture is to be reordered. For example, if the list order 1029, 1027, 502, 255 is to be reordered as 255, 1027, 1029, 502, the list reordering information to be signaled is (in the order as they appear):

VLC code for 255

VLC code for 1027

The decoder 2 processes the two VLC codes in the order as they appear. After processing of the first code, the reference picture with RPN value 255 is put first in the order, and the orders of other reference pictures are put after the first reference picture in the order according to the initial order. The list order then becomes 255,1029, 1027, 502.

After processing of the second code, the reference picture with RPN value 1027 is put second in the order, and the orders of other reference pictures except the one processed above are put after the second reference picture in the order according to the initial order. The list order then becomes 255, 1027, 1029, 502.

A problem of the above method is that the number of bits to signal the original RPN value could be very large since in VLC coding larger values typically have a larger code length.

To save bits for representing the list reordering information, predictive coding of RPN values can be utilized. A possible method is similar as that used for short-term reference picture list reordering in the standard H.264/AVC. Instead of directly signaling the RPN value for the to-be-reordered reference picture, the absolute difference between the prediction and the RPN value minus 1, denoted as AbsDIFFminus1, is signaled, together with an indication of whether the absolute difference is added to or subtracted from the prediction value to derive the RPN value, denoted as ASidc. For the first to-be-reordered reference picture, the prediction value, denoted as predRPN, is equal to RPNcurr. After processing the list reordering information of each to-be-reordered reference picture, predRPN is set equal to PRN value of the just reordered reference picture.

The RPN value of the to-be-reordered reference picture is derived as follows:

```
if(ASidc == 0)
  RPN = predRPN − (AbsDIFFminus1 + 1)
else if(ASidc == 1)
  RPN = predRPN + (AbsDIFFminus1 + 1)
```

For the above example, assuming that RPNcurr is equal to 1030, the list reordering information to be signaled becomes:

AbsDIFFminus1=774, ASidc=0

AbsDIFFminus1=771, ASidc=1

It can be derived that the first to-be-reordered reference picture has RPN value equal to (1030−(774+1)=255), and the second has RPN value equal to (255+(771+1)=1027).

However, as can be seen, the above method is not efficient since the signaled value could still be very large.

The present invention provides an efficient coding of reference picture list reordering information. Prediction of the RPN values of the to-be-reordered reference pictures are used. Three pieces of information are signaled for indication of an RPN value:
1) the absolute difference between the prediction and the RPN value minus 1, denoted as AbsDIFFminus1,
2) an indication of whether addition or subtraction is used to derive the prediction value and the RPN value, denoted as ASidc, and
3) scale of the prediction value denoted as PS. The value of PS shall be selected such that AbsDIFFminus1 is in the range of 0 to MaxFNplus1, exclusive.

For the first to-be-reordered reference picture, the prediction value predRPN is calculates as follows:
predRPN=RPNcurr−PS*MaxFNplus1

After processing the list reordering information of each to-be-reordered reference picture, the prediction value predRPN is first set equal to PRN value of the just reordered reference picture. Then predRPN is updated as follows:

```
if(ASidc == 0)
  predRPN = predRPN − PS * MaxFNplus1
else if(PNidc == 1)
  predRPN = predRPN + PS * MaxFNplus1
```

The RPN value of the to-be-reordered reference picture is derived as follows:

```
if(ASidc == 0)
  RPN = predRPN − (AbsDIFFminus1 + 1)
else if(ASidc == 1)
  RPN = predRPN + (AbsDIFFminus1 + 1)
```

For the above example, assuming that RPNcurr is equal to 1030 and MaxFNplus1 is equal to 256, the list reordering information to be signaled in a signal 300 becomes as follows:

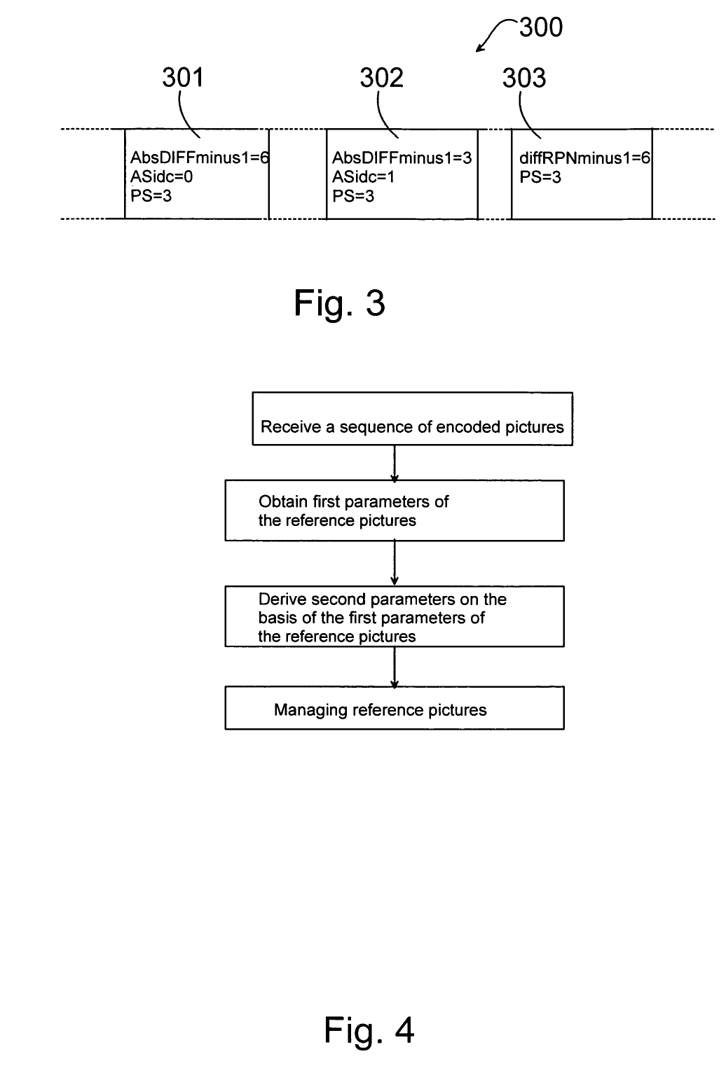

AbsDIFFminus1=6, ASidc=0, PS=3 (this is illustrated with reference 301 in FIG. 3)

AbsDIFFminus1=3, ASidc=1, PS=3 (this is illustrated with reference 302 in FIG. 3)

It can be derived that the first to-be-reordered reference picture has RPN value equal to 1030−3*256−(6+1)=255, and the second to-be-reordered reference picture has RPN value equal to 255+3*256+(3+1)=1027.

It can be seen that the signaled values are small, hence bits can be saved in representations of the reference picture list reordering process.

It should be stated that simple changes of the above method are always possible. For example, the three information pieces may be contained in two syntax elements (by combining ASidc and PS in one syntax element) as well as three syntax elements. The prediction scale PS could be based on a value other than MaxFNplus1 provided that the value can be indicated from the codec specification and/or related signaled information.

Reference Picture Marking

The reference picture marking process is mainly used to mark some reference pictures as “unused for reference” such that they can be removed from the post-decoder buffer 2.1, 5.2 if their output or display times have elapsed. There are two kinds of reference picture making mechanisms, the first-in first-out sliding window method and the customized adaptive marking method.

Methods similar as those for both sliding window marking operation and adaptive marking operation in H.264/AVC can be applied in the scenario where RPN is used to identify reference pictures.

For the sliding window marking operation, whenever the total number of pictures stored in the post-decoder buffer for reference is equal to the maximum value and new reference picture is to be stored, the one having the smallest value of RPN is marked as “unused for reference”.

For the adaptive marking operation, information needed to derive the RPN of the to-be-marked reference picture is signaled. The information to be signaled is the difference between RPNcurr and the RPN value of the to-be-marked reference picture minus 1, denoted as diffRPNminus1.

The RPN value of the to-be-marked reference picture is derived as
RPN=RPNcurr−(diffRPNmius1+1)

For the same example as earlier, if the reference picture with RPN equal to 255 is to be marked as “unused for reference”, the information to be signaled is diffRPNminus1=774.

It can be derived that the reference picture to be marked has RPN value equal to (1030−(774+1)=255).

A problem with the above described prior-art sliding window marking operation is illustrated through the following example. Assuming that RPNcurr is equal to 200, three pictures are stored in the post-decoder buffer for reference with RPN values equal to 60, 198 and 199, the maximum number of stored pictures for reference is 3. For the next to-be-encoded picture, the encoder 1 would still like to have the reference picture with RPN equal to 60 to be stored for later use while to mark the reference picture with PRN equal to 199 as “unused as reference”. In such a case, it would be efficient to use sliding window marking operation. However, the prior-art sliding window marking operation will mark the reference picture with RPN equal to 60 as “unused for reference”.

This invention provides a solution for the above problem. For the sliding window reference picture marking operation, another information is signaled additionally to indicate the size of the sliding window, denoted as SSW. Only the SSW reference pictures with the largest values of RPN are operated according to the first-in first-out rule. Reference pictures with smaller values are not involved.

For example, the additionally signaled information is equal to the difference between the maximum number of stored pictures for reference and SSW. In the above example, the additionally signaled information is then just a code representing 1 (equal to 3−2).

It can also be seen that the prior-art adaptive marking operation is not efficient since the signaled value could be very large. Unfortunately, to directly signal the RPN value of the to-be-marked reference picture is also inefficient.

This invention also provides an efficient signaling method for the adaptive marking operation. Two pieces of information are signaled to mark one reference picture as “unused for reference”:
1) the difference between the prediction of the RPN and the RPN value of the to-be-marked reference picture minus 1, denoted as diffPRNminus1, and
2) the prediction scale indicating how the prediction is derived, denoted as PS.

The value of PS shall be selected such that AbsDIFFminus1 is in the range of 0 to MaxFNplus1, exclusive.

The prediction, denoted as predRPN, is derived as
predRPN=RPNcurr−PS*MaxFNplus1

The RPN value of the to-be-marked reference picture is derived as

$$\begin{matrix}RPN = predRPN - ( diff RPN minus 1 + 1 ) \\ = RPN curr - PS * Max FNplus 1 - ( diffRPN minus 1 + 1 )\end{matrix}$$

For the same example as earlier, if the reference picture with RPN equal to 255 is to be marked as “unused for reference”, the information to be signaled is diffRPNminus1=6, PS=3 (this is illustrated with reference 303 in FIG. 3).

It can be derived that the reference picture to be marked has RPN value equal to (1030−3*256−(6+1)=255).

Again, it should be stated that simple changes of the above method are always possible. For example, the prediction scale PS could be based on a value other than MaxFNplus1 provided that the value can be indicated from the codec specification and/or related signaled information.

In the example system of FIG. 5 the encoder 1 performs the encoding of the picture stream and calculates the values for the parameters. The encoder 1 further initiates a signal transmission for informing the decoder 2 of the receiving device 8 that a reference picture can be removed from the post-decoder buffer 2.1 of the decoder if its display or output time is elapsed. The signal is included with the parameters which indicate the reference picture number, reference picture list reordering information and/or the reference picture marking information. The signal is transmitted by the transmitter 7 of the transmitting device 6.

The present invention can be applied in many kinds of systems and devices. The transmitting device 6 can be e.g. a computing device such as a server device, a video transmitter, a wireless communication device, etc. The receiving device 8 can be a computing device such as a workstation, a wireless communication device, a video receiver etc. The transmitting device 6 including the encoder 1 advantageously include also a transmitter 7 to transmit the encoded pictures to the transmission channel 4. The receiving device 8 include the receiver 9 to receive the encoded pictures, the decoder 2, and optionally a display 10 on which the decoded pictures can be displayed. The transmission channel can be, for example, a landline communication channel and/or a wireless communication channel. The transmitting device and the receiving device also include one or more processors 1.2, 2.2 which can perform the necessary steps for controlling the encoding/decoding process of video stream according to the invention. Therefore, the method according to the present invention can mainly be implemented as machine executable steps of the processors. The buffering of the pictures can be implemented in the memory 1.3, 2.3 of the devices. The program code 1.4 of the encoder can be stored into the memory 1.3. Respectively, the program code 2.4 of the decoder can be stored into the memory 2.3.

What is claimed is:

1. A method for encoding a sequence of pictures comprising:
using one or more pictures as reference pictures;
labeling the reference pictures with a first parameter;
signaling the first parameter to a decoder; and
using a reference picture management;
wherein all the reference pictures are identified by a second parameter which is derived on the basis of the first parameter.

2. A method according to claim 1 comprising
using a frame number FN as said first parameter, and
using a reference picture number RPN as said second parameter.

3. A method according to claim 2 comprising
defining a decoding order for pictures of said sequence of pictures;
defining a parameter prevFN equal to the frame number of the previous reference picture in said decoding order;
defining a parameter prevRPN equal to the reference picture number of the previous reference picture;
defining a maximum value for the frame number;
defining a parameter maxFNplus1 equal to said maximum value for the frame number+1; and
calculating the reference picture number of the reference picture as follows:
```
if(prevFN <= FN)
  RPN = prevRPN + FN − prevFN
else
  RPN = prevRPN + FN − prevFN + maxFNplus1
```

4. A method according to claim 1, the reference picture management comprising reference picture list initialization and reference picture list reordering.

5. A method according to claim 4 comprising signaling
a parameter AbsDIFFminus1 indicative of the absolute difference between the prediction of the RPN and the RPN value, wherein the prediction of the RPN is an expected value of the RPN;
a parameter ASidc indicative of whether the absolute difference is added to or subtracted from the prediction value of the RPN to derive the RPN value; and
a parameter PS indicative of the scale of the prediction value of the RPN.

6. A method according to claim 5 comprising
setting a parameter RPNcurr to the value of the RPN of a first to-be-reordered reference picture;
calculating the prediction value predRPN for the first to-be-reordered reference picture as follows:
predRPN=RPNcurr−PS*MaxFNplus1
setting the prediction value predRPN first equal to PRN value of the previous reordered reference picture; and
updating the predRPN as follows:
```
if(ASidc == 0)
  predRPN = predRPN − PS * MaxFNplus1
else if(PNidc == 1)
  predRPN = predRPN + PS * MaxFNplus1
```

7. A method according to claim 1, the reference picture management comprising reference picture marking.

8. A method according to claim 7 comprising signaling
a parameter diffPRNminus1 indicative of the difference between the prediction of the RPN and the RPN value of the to-be-marked reference picture minus 1; and
a parameter PS indicative of the scale of the prediction value.

9. A method according to claim 8 comprising
setting a parameter RPNcurr to the value of the RPN of a to-be-marked reference picture; and
calculating the reference picture number value RPN for the to-be-marked reference picture as follows:
$$\begin{matrix}RPN = predRPN - ( diff RPN minus 1 + 1 ) \\ = RPN curr - PS * Max FNplus 1 - ( diffRPN minus 1 + 1 )\end{matrix}$$

10. A method for decoding a sequence of encoded pictures comprising:
using one or more pictures as reference pictures, said reference pictures being labeled with a first parameter;
obtaining the first parameter from the encoded pictures; and
using a reference picture management;
wherein all the reference pictures are identified by a second parameter which is derived on the basis of the first parameter.

11. A method according to claim 10, the reference picture management comprising reference picture list initialization and reference picture list reordering.

12. A method according to claim 10, the reference picture management comprising reference picture marking.

13. A method according to claim 10, the reference picture management comprising reference picture reordering and reference picture marking.

14. A signal comprising a sequence of encoded pictures; said sequence comprising one or more reference pictures, said reference pictures being labeled with a first parameter; said signal being used according to claim 1.

15. A hardware for implementing claim 1.

16. A module for encoding a sequence of pictures comprising:
a first element for selecting one or more pictures to be used as reference pictures;
a second element for labeling the reference pictures with a first parameter; a third element for including the first parameter in a signal to be transmitted to a decoder; and
a fourth element for derivation of a second parameter based on the first parameter; wherein all the reference pictures are identified by the second parameter.

17. A module according to claim 16 wherein the module is included in a wireless device.

18. A module for decoding a sequence of encoded pictures, the pictures comprising one or more pictures as reference pictures, said reference pictures being labeled with a first parameter; the module comprising:
a first element for obtaining the first parameter from the encoded pictures;
a reference picture manager; and
a second element for deriving a second parameter on the basis of the first parameter for identifying all the reference pictures.

19. A module according to claim 18 wherein the module is included in a wireless device.

20. A system comprising:
an encoding device for encoding a sequence of pictures comprising:
a first element for selecting one or more pictures to be used as reference pictures;
a second element for labeling the reference pictures with a first parameter;
a third element for including the first parameter in a signal to be transmitted to a decoder;
a fourth element for derivation of a second parameter based on the first parameter; wherein all the reference pictures are identified by the second parameter;
a decoding device for decoding the signal, the decoding device comprising
a fifth element for obtaining the first parameter from the encoded pictures;
a reference picture manager; and
a sixth element for deriving a second parameter on the basis of the first parameter for identifying all the reference pictures.

21. A computer program product comprising software for encoding a sequence of pictures, the software comprising machine executable code stored on a readable medium for execution by a processor, the machine executable code for:
using one or more pictures as reference pictures;
labeling the reference pictures with a first parameter;
including the first parameter in a signal to be transmitted; and
deriving of a second parameter based on the first parameter; wherein all the reference pictures are identified by the second parameter

22. A computer program product comprising software for decoding a sequence of pictures, the software comprising machine executable code stored on a readable medium for execution by a processor, the machine executable code for:
using one or more pictures as reference pictures, said reference pictures being labeled with a first parameter;
obtaining the first parameter from the encoded pictures;
using a reference picture management; and
deriving a second parameter on the basis of the first parameter; and
identifying all the reference pictures by said second parameter.
